(19) United States
(12) Patent Application Publication
(10) Pub. No.: US 2023/0115702 A1
(43) Pub. Date: Apr. 13, 2023

(54) System Event Classification for a Multi-Way Information Handling System Architecture

(71) Applicant: Dell Products L.P., Round Rock, TX (US)

(72) Inventors: Vivek Viswanathan Iyer, Austin, TX (US); Sajjad S. Ahmed, Austin, TX (US); Nikhil Gudikandula, Houston, TX (US)

(73) Assignee: Dell Products L.P., Round Rock, TX (US)

(21) Appl. No.: 17/497,958

(22) Filed: Oct. 10, 2021

(51) Int. Cl. G06F 9/54; G06F 3/14; G06F 1/26

(52) U.S. Cl. CPC G06F 9/542; G06F 3/1454; G06F 1/26

(57) ABSTRACT

A system, method, and computer-readable medium are disclosed for performing a system event classification operation. The system event classification operation includes providing an information handling system with a primary integrated processor system and an ancillary integrated processor system, the primary integrated processor system executing a primary control point service, the ancillary integrated processor system executing an ancillary control point service; classifying a system event by a particular control point action mode; and, configuring the information handling system to automatically operate in a particular control point action mode based upon the classification of the particular control point action mode.

### BACKGROUND OF THE INVENTION

### Field of the Invention

The present invention relates to information handling systems. More specifically, embodiments of the invention relate to performing a system event classification operation.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY OF THE INVENTION

In one embodiment the invention relates to a computer-implementable method for performing a system event classification operation, comprising: providing an information handling system with a primary integrated processor system and an ancillary integrated processor system, the primary integrated processor system executing a primary control point service, the ancillary integrated processor system executing an ancillary control point service; classifying a system event by a particular control point action mode; and, configuring the information handling system to automatically operate in a particular control point action mode based upon the classification of the particular control point action mode.

In another embodiment the invention relates to a system comprising: a primary integrated processor system; an ancillary integrated processor system; a data bus coupled to the processor; and a non-transitory, computer-readable storage medium embodying computer program code, the non-transitory, computer-readable storage medium being coupled to the data bus, the computer program code interacting with a plurality of computer operations and comprising instructions executable by the processor and configured for: executing a primary control point service via the primary integrated processor system; executing an ancillary control point service via the ancillary integrated processing system; classifying a system event by a particular control point action mode; and, configuring the information handling system to automatically operate in a particular control point action mode based upon the classification of the particular control point action mode.

In another embodiment the invention relates to a computer-readable storage medium embodying computer program code, the computer program code comprising computer executable instructions configured for: executing a primary control point service via a primary integrated processor system; executing an ancillary control point service via an ancillary integrated processing system; classifying a system event by a particular control point action mode; and, configuring the information handling system to automatically operate in a particular control point action mode based upon the classification of the particular control point action mode.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a general illustration of components of an information handling system (IHS) as implemented in the system and method of the present invention;

FIG. 2 is a block diagram of an intelligent connectivity environment;

FIG. 3 shows a perspective view of an ancillary user interface implemented on an example portable information handling system;

FIG. 4 shows a simplified block diagram of an IHS implemented with a primary system on a chip (SOC), an ancillary SOC, and an embedded controller (EC);

FIG. 5 shows a simplified block diagram of interactions between a primary SOC, an ancillary SOC, and an embedded controller (EC);

FIG. 6 shows a table of example system event classification use cases;

FIG. 7 shows a table of inputs and outputs associated with various example control point (CP) action modes;

FIG. 8 shows process flows associated with the performance of certain system event classification operations; and

FIGS. 9a through 9e show the performance of certain user interactions with an ancillary user interface (UI).

### DETAILED DESCRIPTION

A system, method, and computer-readable medium are disclosed for performing a system event classification operation. Certain aspects of the invention reflect an appreciation that users of information handling systems are used to, and expect, being able to use their devices to interact anywhere, at any time. Certain aspects of the invention likewise reflect an appreciation that such interactions should ideally be simple and intuitive. However, some interactions, such as changing operating system (OS) settings, checking the status of the system, and selecting certain applications typically require interacting directly with the system through its primary user interface (UI), which can be time consuming. Likewise, certain aspects of the invention reflect an appreciation that the inability to view a system's status, make changes to such settings, or select applications without interacting with the primary UI can be distracting and inconvenient. Accordingly, certain aspects of the invention reflect an appreciation that users generally desire faster, more efficient interactions with their systems, providing the information the user needs as they need it, when they need it.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

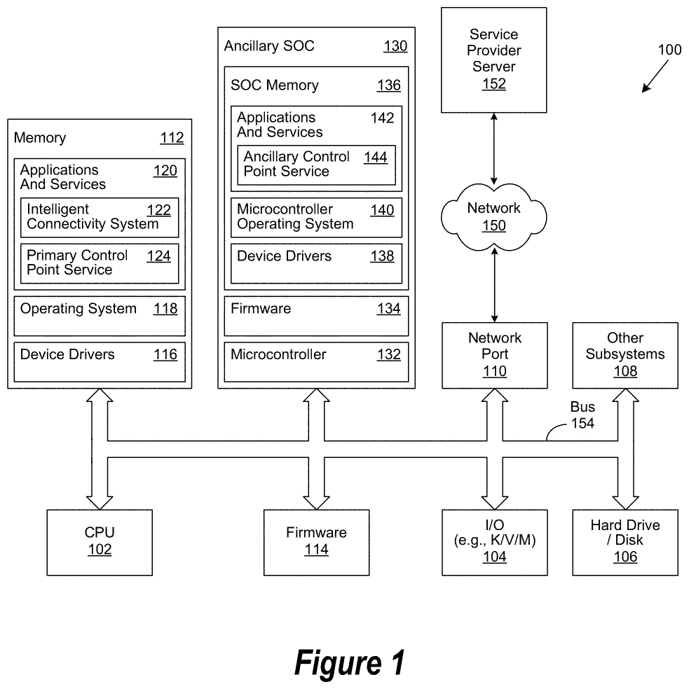

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, a touchpad or touchscreen, and associated controllers, a hard drive or disk storage 106, and various other subsystems 108. In various embodiments, the information handling system 100 also includes network port 110 operable to connect to a network 150, which is likewise accessible by a service provider server 152.

In certain embodiments, the information handling system 100 may likewise include system memory 112, firmware 114, and an ancillary system on a chip (SOC) 130, which is interconnected to the foregoing via one or more buses 154. As used herein, a system on a chip (SOC) may be defined as an integrated processor system which includes at least a processor, random access memory, and read only memory. In various embodiments, the SOC may be implemented within an integrated circuit. In various embodiments, the SOC may additionally include some or all of input/output ports, secondary storage, a radio modem, and a graphic processing unit (GPU). In various embodiments, the system memory 112 may be implemented to include an operating system (OS) 118 and certain device drivers 116. In various embodiments, the system memory 112 may likewise be implemented to include certain software applications and services 120. In certain embodiments, the software applications and services 120 may include an intelligent connectivity system (ICS) 122, or a primary control point (CP) service 124, or both, as described in greater detail herein. In various embodiments, certain functionality of firmware 114 may be implemented in memory 112, using approaches familiar to skilled practitioners of the art.

In various embodiments, the ancillary SOC 130 may be implemented to include a microcontroller 132, SOC memory 136, and certain firmware 134. In various embodiments, the SOC memory 136 may be implemented to include certain device drivers 138, a microcontroller OS 140, and certain software applications and services 142. In certain embodiments, the software applications and services 142 may include an ancillary CP service 144. In one embodiment, the information handling system 100 is able to download the primary CP service 124 and the ancillary CP service 144 from the service provider server 152.

In certain embodiments, the primary CP service 124 or the ancillary CP service 144 may be implemented, individually or in combination, to perform a system event classification operation, as described in greater detail herein. In certain embodiments, the functionality of the ancillary SOC 130 may be implemented in an embedded controller (not shown). In certain embodiments, the system event classification operation may be performed by the primary CP service 124, or the ancillary CP service 144, or both, during operation of an information handling system 100. In certain embodiments, the performance of the system event classification operation may result in the realization of improved operation of the information handling system 100, as described in greater detail herein.

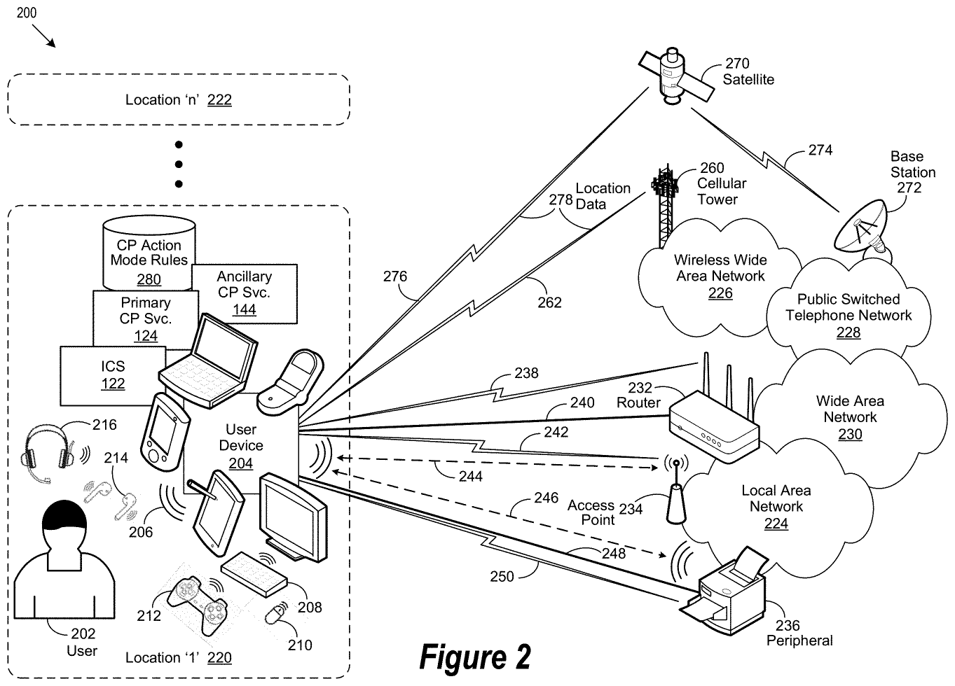

FIG. 2 is a block diagram of an intelligent connectivity environment implemented in accordance with an embodiment of the invention. In certain embodiments, the intelligent connectivity environment 200 may include an intelligent connectivity system (ICS) 122, a primary control point (CP) service 124, or an ancillary CP service 144, or a combination thereof, as described in greater detail herein. In certain embodiments, the ICS 122, the primary CP service 124, and the ancillary CP service 144 may be implemented on a user device 204. As used herein, a user device 204 broadly refers to an information handling system (IHS) such as a personal computer, a laptop computer, a tablet computer, a personal digital assistant (PDA), a smart phone, a mobile telephone, or other device that is capable of communicating and processing data.

In certain embodiments, a user 202 may use the user device 204 to interact with the ICS 122, the primary CP service 124, or the ancillary CP service 144, or a combination thereof. In certain embodiments, the ICS 122 may be implemented to perform an intelligent connectivity operation. As used herein, an intelligent connectivity operation broadly refers to any operation whose performance improves a user device's ability to utilize, as described in greater detail herein, network connectivity that may be available for provision by one or more networks.

In various embodiments, the primary CP service 124 and the ancillary CP service 144 may be implemented, individually or in combination, to perform a system event classification operation. As used herein, a system event broadly refers to a point in time that an identifiable computing task associated with a particular IHS occurs. As likewise used herein, a system event classification operation broadly refers to any operation performed to classify a particular system event by an associated CP action mode. As likewise used herein, a CP action mode broadly refers to a mode of system operation that defines which CP actions associated with a particular system event, described in greater detail herein, are respectively performed, under what circumstances, by the primary CP service 124, or the ancillary CP service 144, or both. In certain embodiments, a CP action mode may be implemented to define when control of the execution of a particular CP action is transferred between a primary CP service 124 and an ancillary CP service 144, and under what circumstances.

As likewise used herein, a CP action broadly refers to any action, operation or process that can be performed by a primary CP service 124, or an ancillary CP service 144, or the two in combination. In certain embodiments, performance of a particular CP action may be initiated as a result of an IHS receiving certain associated system event input information. In various embodiments, the system event input information may be provided in the form of user input, as described in greater detail herein. In certain of these embodiments, the user input may be received as a result of user interaction with an ancillary user interface (UI), as likewise described in greater detail herein. In certain embodiments, as likewise described in greater detail herein, user input received as a result of user interaction with an ancillary UI may be processed by an associated ancillary SOC.

In various embodiments, the system event input information may be provided in the form of information provided by one or more components associated with the IHS. As an example, the IHS may be implemented with one or more components, which in turn may be implemented, individually or in combination, to provide location information (e.g., a collaboration room), network connectivity availability information (e.g., wireless access point connectivity), proximity and availability of certain peripherals (e.g., a wireless-enabled display monitor), and so forth. In various embodiments, the primary CP service 124, or the ancillary CP service 144, or both, may be implemented to use certain CP action mode rules 280 in the performance of a particular CP action, as described in greater detail herein. In these embodiments, the definition of the CP action mode rules 280, and the method by which they may be used by the primary CP service 124, or the ancillary CP service 144, or both, in the performance of a particular CP action is a matter of design choice.

In certain embodiments, the intelligent connectivity environment 200 may include a Local Area Network (LAN) 224, a Personal Area Network (PAN) 206, a Wireless Local Area Network (WLAN), a Wireless Wide Area Network (WWAN) 226, a satellite 270 network, the public switched telephone network (PSTN) 228, and a Wide Area Network (WAN) 230, such as the Internet, or a combination thereof. In certain embodiments, the LAN 224 may be based upon one or more protocols, such as Ethernet, Asynchronous Transfer Mode (ATM), Token Ring, or Fiber Distributed Data Interface (FDDI). In certain embodiments, the PAN 206 may be based upon one or more protocols commonly associated with Bluetooth, ZigBee, or ultrawideband (UWB). In certain embodiments, the WLAN may be based upon one or more variants of the IEEE 802.11 wireless communication standard. In certain embodiments, the WWAN 226 may be based upon one or more generations of known cellular network protocols, commonly referred to as 3G, 4G, 5G, and so forth. In certain embodiments, the WAN 230 may be based upon one or more protocols, such as X.25, Frame Relay, Asynchronous Transfer Mode (ATM), or Telecommunications Protocol/Internet Protocol (TCP/IP).

In certain embodiments, the user device 204 may be implemented with communication hardware and software that allows it to communicate with one or more wirelessly-enabled input/output (I/O) devices via a PAN 206 network link. Examples of such wirelessly-enabled I/O devices include a keyboard 208, a mouse 210, a game controller 212, earphones or earbuds 214, a headset 216, and so forth. Skilled practitioners of the art will be familiar with a network link, which as commonly used, refers to the physical and logical network component used to interconnect hosts or nodes in a network. Those of skill in the art will likewise be aware that such network links are generally established through the link layer of a telecommunications protocol stack, such as the Internet protocol suite or the Open Systems Interconnection (OSI) model. As typically implemented, the link layer refers to a group of methods and communications protocols confined to the network link that a host, such as a particular user device 204 is physically connected to.

In certain embodiments, the user device 204 may be implemented with communication hardware and software that allows it to communicate with one or more access points 234 via a PAN 242 network link, or a WLAN 244 network link, or both. Skilled practitioners of the art will be familiar with a wireless access point (AP) 234, which generally refers to a networking hardware device that allows a wirelessly-enabled device, such as a particular user device 204, to connect to a wired network, such as a LAN 224. In various embodiments, the AP 234 may be implemented as a stand-alone device. In certain of these embodiments, the AP 234 may be implemented to connect to a router 232 through a LAN 224. In certain embodiments, the functionality of an AP 234 may be implemented as an integral component of the router 232.

In certain embodiments, the user device 204 may be implemented with communication hardware and software that allows it to communicate with one or more peripherals 236 via a PAN 246 network link, a LAN 248 network link, or a WLAN 250 network link, or a combination thereof. In certain embodiments, the user device 204 may be implemented with communication hardware and software that allows it to communicate with one or more routers 232 via a LAN 240 network link, or a WLAN 238 network link, or both. In certain embodiments, the user device 204 may be implemented with communication hardware and software that allows it to communicate with one or more WWAN 226 cellular towers 260 via a WWAN 262 network link. In certain embodiments, the user device 204 may be implemented with communication hardware and software that allows it to communicate with one or more satellites 270 via a satellite 276 network link.

In various embodiments, a particular cellular tower 260, or a particular satellite 270, or a combination of the two, may be implemented, individually or in combination, to provide certain location data 278, familiar to those of skill in the art, to the user device 204. In certain embodiments, the user device 204 may be configured to receive such location data 278, which is used as a data source for determining the user device's 204 location ‘1’ 220 through ‘n’ 222. In certain embodiments, the location data 278 may include Global Position System (GPS) data provided by a GPS satellite 270. In certain embodiments (not shown), the location data 278 may include various Internet Protocol (IP) or other network address information assigned to the user device 204. In certain embodiments (not shown), the location data 278 may likewise be provided by a router 232, or an AP 234, or both.

In certain embodiments, one or more satellites 270 may be implemented to use known satellite communication protocols to establish a satellite network link 274 to a base station 272. In various embodiments, the base station 272 may in turn be implemented to be connected to the PSTN 228, which in certain embodiments may likewise be implemented to be connected to one or more WWANs 230, or one or more WANs 230, or a combination thereof. In various embodiments, one or more LANs 224 may be implemented to be connected to one or more WANs 230, or a combination thereof. In certain of these embodiments, one or more routers 232, may be implemented, individually or in combination, to connect a particular LAN 224 to a particular WAN 230.

In various embodiments, the ICS 122 may be implemented to establish a particular network link 206, 238, 240, 242, 244, 246, 248, 250, 262, 276 as the user device 204 moves from location ‘1’ 220 to location ‘n’ 222. In certain of these embodiments, the establishment of a particular network link 206, 238, 240, 242, 244, 246, 248, 250, 262, 276 may be based upon the availability of connectivity to a corresponding network. In various embodiments, the ICS 122 may be implemented to switch from one network link 206, 238, 240, 242, 244, 246, 248, 250, 262, 276 to another. In certain of these embodiments, such switching may be based upon the respective signal strength, available bandwidth, network latency, or a combination thereof, associated with the availability of connectivity to a corresponding network.

In certain embodiments, the ICS 122 may be implemented to switch from one network link 206, 238, 240, 242, 244, 246, 248, 250, 262, 276 to another according to the user device 204 being present at a particular location ‘1’ 220 through ‘n’ 222. In various embodiments, the ICS 122 may be implemented to establish two or more simultaneous network links 206, 238, 240, 242, 244, 246, 248, 250, 262, and 276. In certain of these embodiments, bandwidth respectively corresponding to the two or more network links 206, 238, 240, 242, 244, 246, 248, 250, 262, and 276 may be combined to provide aggregated network link bandwidth for use by the user device.

In various embodiments, the ICS 122 may be implemented to assign network connectivity corresponding to a particular software application, or a user device 204 process, to a particular network link 206, 238, 240, 242, 244, 246, 248, 250, 262, 276. In certain embodiments, the ICS 122 may be implemented to respectively assign two or more software applications, or user device 204 processes, to two or more network links 206, 238, 240, 242, 244, 246, 248, 250, 262, and 276 according to their corresponding attributes. For example, the ICS 122 may be implemented to assign a wireless-enabled gaming controller 212 to a PAN 206 link, while information generated and received by a game executing on the user device 204 may be assigned to WLAN 238 network link.

In certain of these embodiments, the respective assignment of two or more software applications, or user device 204 processes, or a combination thereof, to two or more network links 206, 238, 240, 242, 244, 246, 248, 250, 262, 276 may be according to the user device 204 being present at a particular location ‘1’ 220 through ‘n’ 222. As an example, only a lower-speed (e.g., 300 Mbps) WLAN 238 network link may be available at location ‘1’ 220, but both a high-speed (e.g., 100 Gbps) LAN 240 network link and a higher-speed (e.g., 1.7 Gbps) WLAN 238 network link may be available at location ‘n’ 222. In this example, the user 202 may wish to play a particular online game while simultaneously conducting an online chat session, whether they are at location ‘1’ 220 or ‘n’ 222. To continue the example, it is possible that the bandwidth of the WLAN 238 network link at location ‘1’ 220 may be barely adequate to support the network connectivity needs of the on-line game. As a result, the additional overhead of network traffic associated with the online chat session may result in the game not performing as responsively as desired.

However, the ICS 122 may be implemented to respectively assign the online chat session to the higher-speed WLAN 238 network link and the online game to the high-speed LAN 240 network link available at location ‘n’ 222. Accordingly, responsiveness of the online game will likely be improved due to the 100 Gbps speed provided by the LAN 238 network link available at location ‘n’ 220, while the online chat session will be adequately supported by the 1.7 Gbps speed of the WLAN 240 network link. Skilled practitioners of the art will recognize that many such embodiments and examples are possible. Accordingly, the foregoing is not intended to limit the spirit, scope or intent of the invention.

In certain embodiments, the ICS 122 may be implemented to establish and manage one or more virtual private network (VPN) connections on one or more corresponding network links. Skilled practitioners of the art will be familiar with a VPN, which as typically implemented, uses known tunneling protocols to extend a private network, such as a private LAN 224, across a public WAN 230, such as the Internet, to enable users 202 to use their user devices 204 to send and receive data to and from an external resource, such as a remote server, as if it was directly connected to the private network. Certain embodiments of the invention reflect an appreciation that a single VPN may not always be sufficient for a particular operational mode. Accordingly, in certain embodiments, the ICS 122 may likewise be implemented to perform a multi-link network traffic routing operation. As used herein, a multi-link traffic routing operation broadly refers to any operation performed to route network traffic across two or more network links.

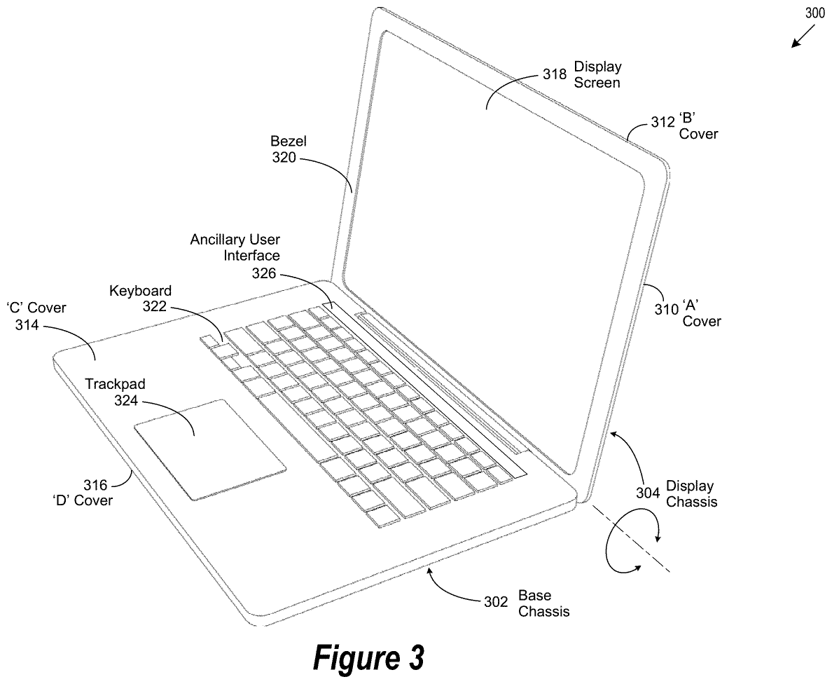

FIG. 3 shows a perspective view of an ancillary user interface implemented in accordance with an embodiment of the invention on an example portable information handling system (IHS). It will be appreciated that some or all of the components of the IHS 100 described in the text associated with FIG. 1 may be included within the portable IHS 300 shown in FIG. 3. As shown in FIG. 3, the portable IHS 300 may be configured to include a base chassis 302 and a display chassis 304 shown in an open configuration. It will be appreciated that a closed configuration would have the display chassis 304 fully closed onto the base chassis 302.

In certain embodiments, the base chassis 302, or the display chassis 304 of the portable IHS 300, or the two combined, may comprise an outer case or shell. In certain embodiments, the portable IHS 300 may include a plurality of chassis portions. In certain embodiments, the portable IHS 300 may include some or all of an ‘A’ cover 310, a ‘B’ cover 312, a ‘C’ cover 314, and a ‘D’ cover 316. In certain embodiments, the ‘A’ cover 310 and the ‘B’ cover 312 may be configured to provide the display chassis 304. In certain embodiments, the ‘C’ cover 314 and the ‘D’ cover 316 may be configured to provide the base chassis 302.

In certain embodiments, the ‘A’ cover 310 may be configured to enclose a portion of the display chassis 304 of the IHS 300. In certain embodiments, the ‘B’ cover 312 may be configured to enclose another portion of the display chassis 304 of the IHS 300. In certain embodiments, the ‘B’ cover 312 may be configured to include a display screen 318 and an associated bezel 320.

In certain embodiments, the ‘C’ cover 314 may be configured to enclose a portion of the base chassis 302 of the IHS 300. In certain embodiments, the ‘C’ cover 314 may be configured to include a keyboard 322, a trackpad 324, an ancillary user interface (UI) 326, other input/output (I/O) devices (not shown), or a combination thereof. In certain embodiments (not shown) the ancillary UI 326 may be configured to be incorporated into the display screen 318, its bezel 320, or the ‘A’ cover 310 of the portable IHS 300, or a combination thereof. In various embodiments, certain components of the portable IHS 300, such as a mother board, may be mounted within the ‘C’ cover 314. In certain embodiments, the ‘D’ cover 316 may be configured to enclose another portion of the base chassis 302 of the portable IHS 300.

In certain embodiments, the ‘A’ cover 310 may be configured to form a top outer protective shell, or a portion of a lid, for the portable IHS 300, while the ‘D’ cover 316 may be configured to form a bottom outer protective shell, or a portion of a base, for the portable IHS 300 when placed in a closed configuration. In certain embodiments, the ‘A’ cover 310 and the ‘D’ cover 316 may be substantively parallel to one another when in a fully closed configuration. In certain embodiments, both the ‘A’ cover 310 and the ‘D’ cover 316 may be comprised entirely of metal. In certain embodiments, the ‘A’ cover 310 and ‘D’ cover 316 may include both metallic and plastic components. For example, plastic components that are radio-frequency (RF) transparent may be used to form a portion of the ‘A’ cover 310.

In various embodiments, the ‘A’ cover 310 may be movably connected to a back edge of the ‘D’ cover 316 via one or more hinges. In certain of these embodiments, the hinges may be configured to allow the ‘A’ cover 310 to rotate from and to the ‘D’ cover 316, allowing for multiple orientations of the portable IHS 300. In certain embodiments, the portable IHS 300 may include a sensor to detect the orientation of the portable IHS 300 and activate or deactivate one or more antenna systems based on the occurrence of a particular orientation.

In certain embodiments, the portable IHS 300 may be a laptop with limited rotation of the ‘A’ cover 310 with regard to the ‘D’ cover 316, for example up to a 180 degree rotation arc. In certain embodiments the portable IHS 300 may be configured as a convertible IHS 300, with full rotation to a tablet configuration. In various embodiments, the portable IHS 300 may be configured as a tablet computer or a mobile phone. In certain of these embodiments (not shown), the keyboard 322, trackpad 324, display screen 318, bezel 320, and ancillary UI 326, of some combination thereof, may be integrated into the ‘A’ cover. In these embodiments, ‘B’ cover 310 and ‘C’ cover 314 are not implemented in the portable IHS 300, while the ‘D’ cover 316 may be implemented to form a bottom outer protective shell.

In various embodiments, the ancillary UI 326 may be implemented in the form of an adaptive row display (ARD). In certain of these embodiments, the ARD may be implemented to include a touch-capacitive screen, familiar to those of skill in the art, that is capable of displaying information in the form of text or icons, or a combination of the two. In certain embodiments, the touch-capacitive screen of such an ARD may be implemented to receive user input through a user gesture, such as a finger tap on a particular icon or text displayed within the ARD. In various embodiments, the ARD may be implemented in the shape of a bar. In certain embodiments, one or more ARD's may be placed on the surface of the ‘C’ cover 314 above the keyboard 322, on the surface of the ‘B’ cover within the bezel 320 or display screen 318, or on the surface of the ‘A’ cover 310 or ‘D’ cover 316, or a combination thereof.

In various embodiments, the ancillary UI 326 may be implemented to display certain information related to the system configuration mode, described in greater detail herein, the portable IHS 300 may be currently be in. In certain of these embodiments, the ancillary UI 326 may likewise be implemented to display one or more operational parameters associated with its current system configuration mode. In various embodiments, the ancillary UI 326 may be implemented to provide certain user input received from a user to an ancillary control point (CP) service, described in greater detail herein, that is executing on an associated ancillary system on a chip (SOC), likewise described in greater detail herein. In certain of these embodiments, as described in greater detail herein, the ancillary CP service may be implemented to use the provided user input to perform a system event classification operation, likewise described in greater detail herein.

In various embodiments, the ancillary CP service may be implemented to provide certain information associated with the results of a particular system event classification operation to the ancillary UI 326. In certain embodiments, the ancillary UI 326 may be implemented to display such information for a user to view. Skilled practitioners of the art will recognize that many such embodiments are possible. Accordingly, the foregoing is not intended to limit the spirit, scope, or intent of the invention.

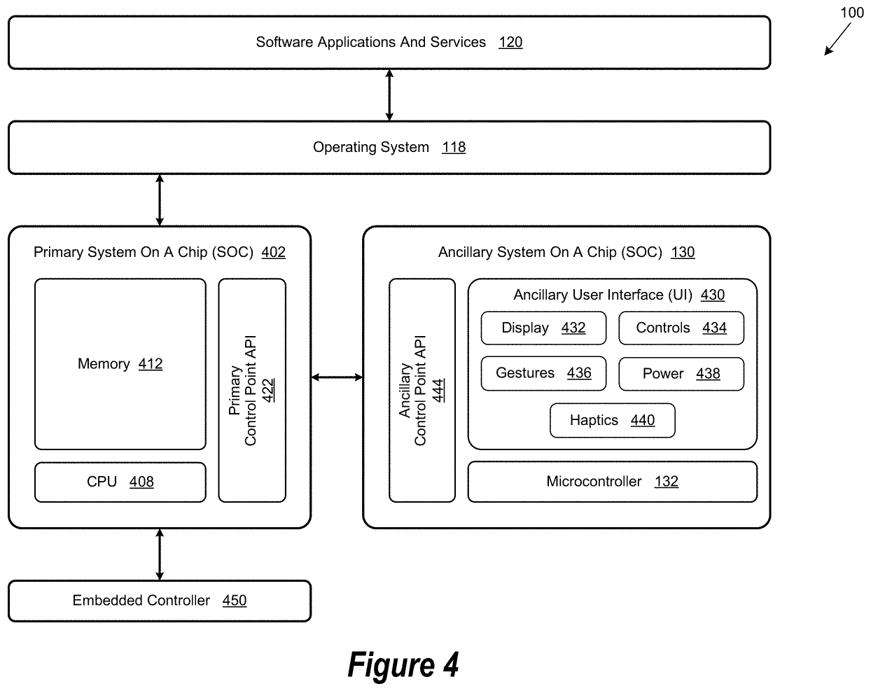

FIG. 4 shows a simplified block diagram of an information handling system (IHS) implemented in accordance with an embodiment of the invention with a primary system on a chip (SOC), an ancillary SOC, and an embedded controller (EC). In various embodiments, an IHS 100 may be implemented to include a primary SOC 402, an ancillary SOC 130, an operating system (OS) 118, and certain software applications and services 120. In certain of these embodiments, the IHS 100 may be implemented to include an embedded controller (EC) 450. In various embodiments, some or all of the functionality provided by the ancillary SOC 130 may be implemented in the embedded controller (EC) 450. In these embodiments, the particular functionality of the ancillary SOC 130 implemented in the EC 450, and the method by which it is implemented, is a matter of design choice.

In certain embodiments, the primary SOC 402 and the ancillary SOC 130, individually or in combination, may be implemented to perform a system event classification operation, described in greater detail herein. In certain embodiments, the primary SOC 402 may be implemented to include a central processing unit (CPU), memory 412, and an a primary control point (CP) application program interface (API) 422. In certain embodiments, some or all of the functional capabilities of the primary SOC 402 may be provided by some or all of the individual components of the information handling system (IHS) described in the descriptive text associated with FIG. 1.

In various embodiments, the ancillary SOC 130 may be implemented to include a microcontroller 132, an ancillary user interface (UI) 430, and an ancillary CP API 444. In various embodiments, the ancillary UI 430 may be implemented to include certain UI functionalities known to skilled practitioners of the art. In various embodiments, such UI functionalities may include the display 432 of certain information related to one or more SOC actions, user controls 434 used to receive certain user input, recognition of certain user gestures 436, certain IHS power status 438 indicators, and haptic 440 feedback.

In various embodiments, the primary CP API 422 and the ancillary CP API 444 may be respectively implemented to exchange certain information associated with a particular system event classification operation between the primary SOC 402 and the ancillary SOC 130. In certain of these embodiments, the system event classification information exchanged between the primary CP API 422 and the ancillary CP API 442 may be associated with the performance of a particular CP action, described in greater detail herein. In various embodiments, such information may include SOC control point information defining whether the primary SOC 402 or the ancillary SOC 130 is responsible for executing a portion, or the entirety, of a particular CP action.

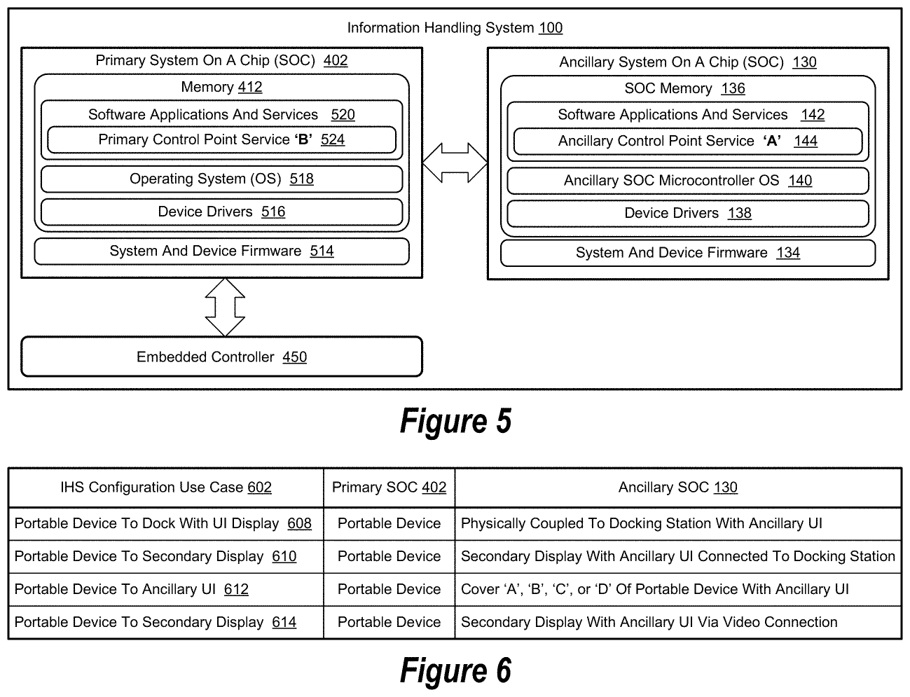

FIG. 5 shows a simplified block diagram of interactions between a primary system on a chip (SOC), an ancillary SOC, and an embedded controller (EC) implemented in accordance with an embodiment of the invention. In certain embodiments, an information handling system (IHS) 100, described in greater detail herein, may be configured to include a primary SOC 402, an ancillary SOC 130, and an EC 450. In various embodiments, the primary SOC 402 may be implemented to include memory 412, certain system and device firmware 514, and certain other components (not shown) familiar to skilled practitioners of the art.

In certain embodiments, the memory 412 of the primary SOC 412 may be implemented to include certain system and device drivers 516, an operating system (OS) 518, and certain software applications and services 520. In certain embodiments, the software applications and services 520 may be implemented to include a primary control point (CP) service ‘B’ 524, described in greater detail herein. In various embodiments, some or all of the functionality provided by the primary SOC 402 may be provided by certain discrete components (e.g., central processing unit, various input/output ports, etc.) of the IHS 100 described in the text associated with FIG. 1.

In various embodiments, the ancillary SOC 130 may be implemented to include certain system and device firmware 134, SOC memory 136, and certain other SOC components (not shown) familiar to those of skill in the art. In various embodiments, the SOC memory 136 may be implemented to include one or more device drivers 138, an ancillary SOC microcontroller OS 140, and certain software applications and services 142. In certain embodiments, the software applications and services 142 may be implemented to include an ancillary CP service ‘A’ 144.

In various embodiments, the ancillary CP service ‘A’ 144 may be implemented to receive certain user input, as described in greater detail herein. In various embodiments, the ancillary CP service ‘A’ 144 may be implemented to use such user input to interact with the primary CP service ‘B’ 524, as described in greater detail herein, during the performance of a system event classification operation, likewise described in greater detail herein. In various embodiments, as likewise described in greater detail herein, the performance of one or more system event classification operations may result in a particular system event being assigned a corresponding CP action mode classification.

FIG. 6 shows a table of example information handling system (IHS) configuration use cases implemented in accordance with an embodiment of the invention. In various embodiments, an IHS may be configured to include a primary system on a chip (SOC) 402, an ancillary SOC 130, and an ancillary user interface (UI), or a combination thereof, as described in greater detail herein. In various embodiments, the IHS may be configured according to a particular IHS configuration use case 602.

In certain embodiments, the IHS may be configured such that the primary system on a chip (SOC) 402, the ancillary SOC 130, and the ancillary user interface (UI), or a combination thereof, are all integrated within the IHS itself, as described in greater detail herein. In various embodiments, the IHS may be configured such that one or more of the primary system on a chip (SOC) 402, the ancillary SOC 130, and the ancillary user interface (UI), or a combination thereof, may be integrated within the IHS itself, and others may be implemented in an associated device. In certain of these embodiments, the IHS and the associated device may be mechanically coupled, or electrically coupled via a cable, or communicatively coupled via a network connection, as described in greater detail herein, or a combination thereof.

As an example, in one IHS configuration use case 602 a portable device may be configured 608 to dock with a physical docking station. In this example, the primary SOC 402 may be implemented within the IHS itself, while the ancillary SOC 130 may be implemented within the docking station. To continue the example, an ancillary UI associated with the ancillary SOC 130 may be located on a particular surface of the docking station. As another example, in one IHS configuration use case 602 a portable device may be configured 610 to access a secondary display that is physically connected to a physical docking station. In this example, the IHS connects to the secondary monitor via a video connection. To continue the example, the primary SOC 402 may be implemented to be located within the IHS itself, while the ancillary SOC 130 may be implemented to be located within the secondary display, which likewise is implemented with an associated ancillary UI.

As yet another example, in one IHS configuration use case 602 a portable device may be configured 612 to include the primary SOC 402, the ancillary SOC 130, and its associated ancillary UI. In this example, the ancillary SOC 130 may be implemented either within the base chassis, or the display chassis, of the IHS, as described in the text associated with FIG. 3. To continue the example, the ancillary UI may be implemented on the ‘A,’ ‘B,’ ‘C,’ or ‘D’ cover of the IHS, as likewise described in the text associated with FIG. 3. As yet still another example, in one IHS configuration use case 602 a portable device may be configured 614 to access a secondary display that is physically connected to the IHS. In this example, the IHS connects to the secondary monitor via a video connection. To continue the example, the primary SOC 402 may be implemented to be located within the IHS itself, while the ancillary SOC 130 may be implemented to be located within the secondary display, which likewise is implemented with an associated ancillary UI.

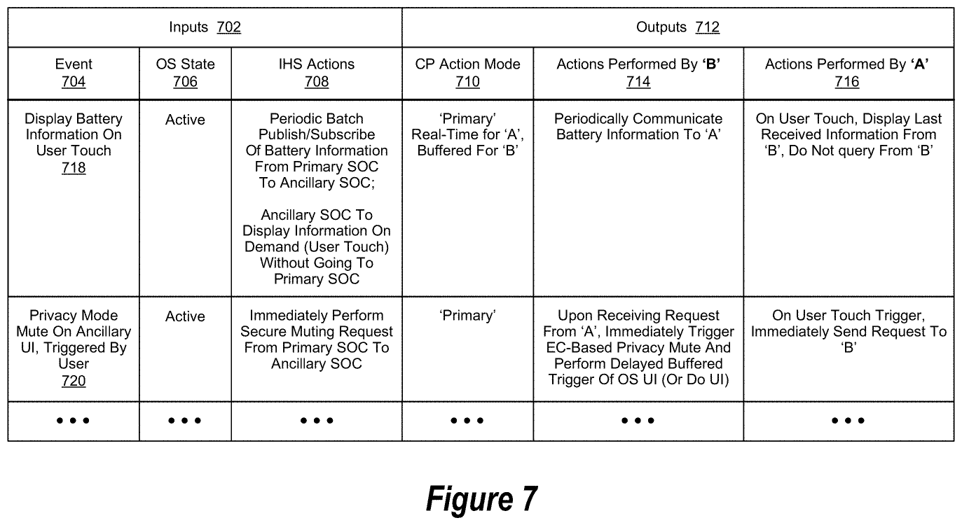

FIG. 7 shows a table of inputs and outputs associated with various example control point (CP) action modes implemented in accordance with an embodiment of the invention. In various embodiments, as described in greater detail herein, a system event classification operation may be performed to classify a particular system event with a corresponding CP action mode. In various embodiments, a CP action mode may have certain associated inputs 702 and outputs 712. In certain of these embodiments, the inputs 702 may include a particular system event 704, an operating system (OS) state 706, and associated information handling system (IHS) actions. Likewise the outputs 712 may include a particular CP action mode 710, the actions performed by a primary CP service ‘B’ 714, and the actions performed by an ancillary CP service ‘A’ 716.

In certain embodiments, performance of a system event classification operation may result in the system event being classified as a primary CP action mode 710, an ancillary CP action mode 710, or an augmented CP action mode 710. As used herein, a primary CP action mode 710 broadly refers to a system mode of operation where the control point of one or more CP actions, described in greater detail herein, is shared between the primary CP service ‘B’ 714 and the ancillary CP service ‘A’ 716. For example, as shown in FIG. 7, the system event 704 of displaying battery information in response to a user's input on an ancillary user input (UI) 718, may have the IHS's OS state 706 be active, and performing corresponding IHS actions 708. In this example, the IHS actions 708 may include periodic batch publish/subscribe operations being performed to provide battery information from a primary SOC to an ancillary SOC.

Likewise, the associated primary CP action mode 710 may designate that actions 716 performed by the ancillary CP service ‘A’ be performed in real-time, while the actions 714 performed by the primary CP service ‘B’ be buffered. In this example, the actions 714 performed by the primary CP service ‘B’ may include periodically communicating battery information to the ancillary CP service ‘A’. Likewise, the actions 716 performed by the ancillary CP service ‘A’ may include displaying the last battery information received from the primary CP service ‘B’ without performing a query for the latest battery information.

As another example, the system event 704 of entering a privacy mode in response to a user's input on an ancillary UI 720, may have the IHS's OS state 706 be active, and performing corresponding IHS actions 708. In this example, the IHS actions 708 may include immediately performing a secure muting request received by the primary SOC from an ancillary SOC. Likewise, the associated primary CP action mode 710 may designate that actions 714 performed by the primary CP service ‘B’ may include immediately triggering an embedded controller (EC) based privacy mute operation and performing a delayed buffered trigger of the OS UI. Likewise, the actions 716 performed by the ancillary CP service ‘A’ may include immediately sending a privacy mute request to the primary CP service ‘B’ upon receiving input from the user on an associated ancillary UI.

Other examples of CP actions associated with a primary CP action mode include allowing for UI interactions with an ancillary CP service ‘A’ through an associated ancillary UI, and presenting visual or haptic responses, or both, through an associated ancillary UI. Yet other examples of CP actions associated with a primary CP action mode include interacting with a primary SOC through CP application programming interface (API), described in greater detail herein, and directly interacting with a primary SOC via device drivers or out of band (00B). Yet still other examples of CP actions associated with a primary CP action mode include notifying the primary SOC of a particular CP action performed by an ancillary SOC, and sending a notification from the primary SOC to a wearable device associated with a particular user.

As likewise used herein, an ancillary CP action mode 710 broadly refers to a system mode of operation where the control point of one or more CP actions are performed solely by the ancillary CP service ‘A’ 716. Examples of CP actions associated with an ancillary CP action mode include displaying baseline IHS information (e.g., battery, connectivity, and OS status, etc.) on an ancillary UI associated with the ancillary SOC, and allowing UI interaction with the ancillary UI through its associated ancillary UI. Other examples of CP actions associated with an ancillary CP action mode include directly interacting with the ancillary SOC, and performing certain computational operations on the ancillary SOC. Yet other examples of CP actions associated with an ancillary CP action mode include not providing the results of certain computational operations to the primary SOC, and performing supplemental operations on information provided by the primary SOC, and then using the ancillary UI to provide the results of those operations to the user.

An augmented CP action mode 710, as likewise used herein, broadly refers to a system mode of operation where the control point of one or more CP actions may be performed by a system that is not part of an IHS. Examples of CP actions associated with an augmented CP action mode include a voice recognition being trained on verbal phrases vocalized by a user, with resulting verbal commands being provided as input data for use by either the primary SOC, or the ancillary SOC, or both, to use in the performance of one or more associated CP actions. Other examples of CP actions associated with an ancillary CP action mode include triggering computational operations on a different IHS, and triggering computational operations performed by a cloud service. Those of skill in the art will recognize that many such CP action modes 710, and their associated CP actions, are possible. Accordingly, the foregoing is not intended to limit the spirit, scope, or intent of the invention.

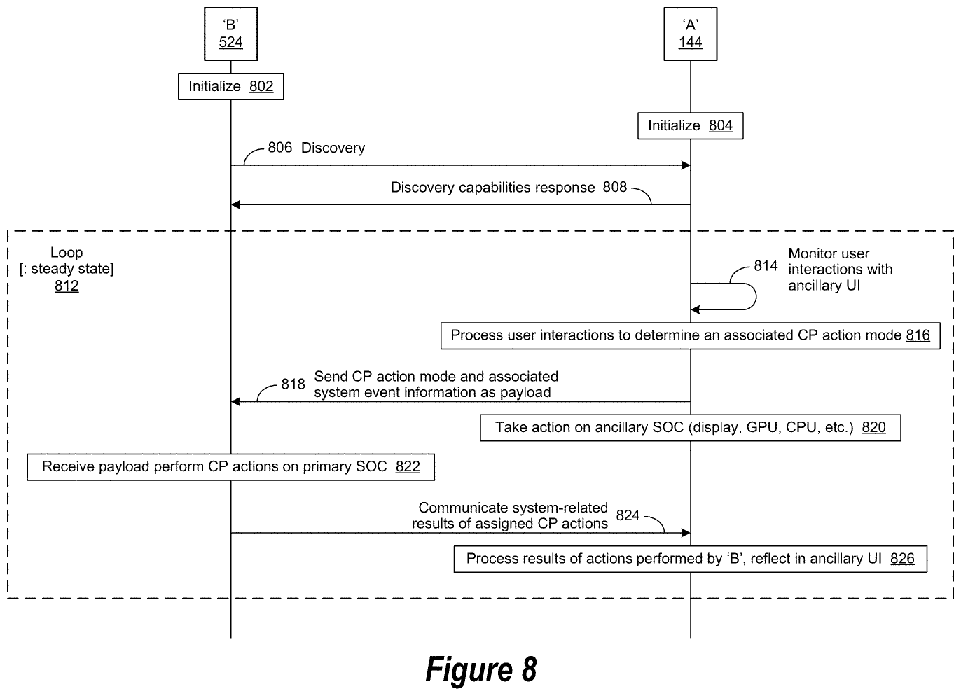

FIG. 8 shows process flows associated with the performance of certain system event classification operations implemented in accordance with an embodiment of the invention. In certain embodiments, a primary control point (CP) service ‘B’ 524 may be implemented on a primary SOC, while an ancillary CP service ‘A’ 144 may be implemented on an ancillary SOC, as described in greater detail herein. In this embodiment, system event classification operations are begun by the ancillary CP service B′ 524 and the ancillary CP service ‘A’ 122 being sequentially initialized in steps 802 and 804. Then, in step 806, the primary CP service ‘B’ 524 performs a discovery operation to discover the capabilities of the ancillary CP service ‘A’ 144. In response, the ancillary CP service ‘A’ 144 provides its capabilities to the primary CP service ‘B’ 142 in step.

Ongoing steady-state loop operations are then initiated in step 812, followed by the ancillary CP service ‘A’ 144 monitoring an ancillary user interface (UI) for the occurrence of user interactions in step 814, as described in greater detail herein. Identified user interactions with the ancillary UI are then collected in step 816 as system event input information, described in greater detail herein, which is then processed to determine an associated CP action mode, likewise described in greater detail herein. In various embodiments, the system event input information may be collected and processed by the ancillary CP service ‘A’ 144 according to certain CP action rules, described in greater detail herein. The ancillary CP service ‘A’ 144 then sends the collected system event information, and its associated CP action mode, as a payload to the primary CP service ‘B’ in step 818.

Then, in step 820, the ancillary CP service ‘A’ 144 processes its assigned portion of CP actions on its associated ancillary SOC according to the CP action mode determined in step 816. Likewise, the primary CP service ‘13’ 524 processes its assigned portion of CP actions on its associated primary SOC according to the CP action mode determined in step 818. Thereafter, in step 824, the primary CP service ‘B’ communicates the results of the CP actions it has performed to the ancillary CP service ‘A’ 144, which then displays them on the ancillary UI in step 826.

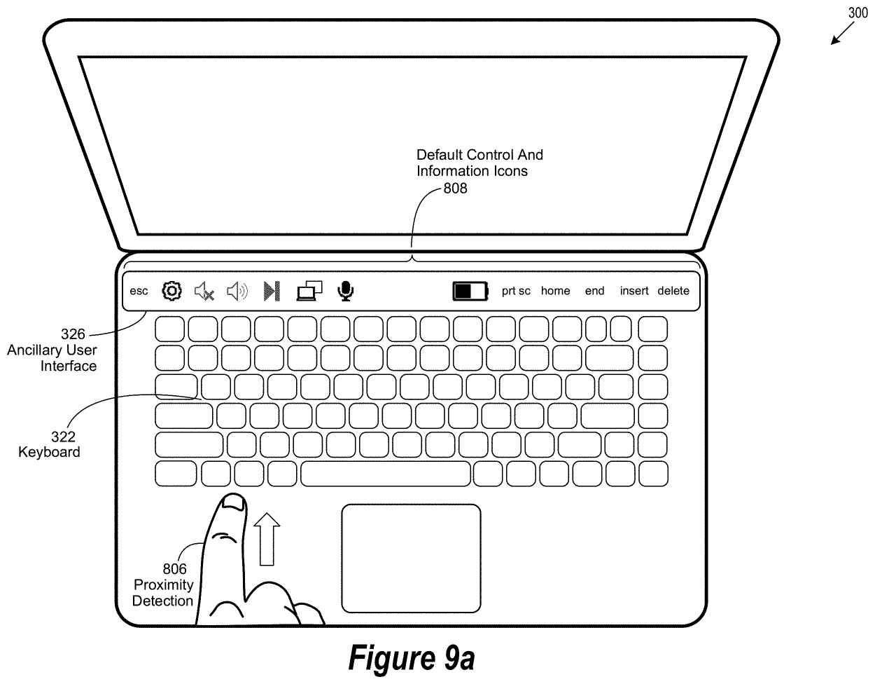

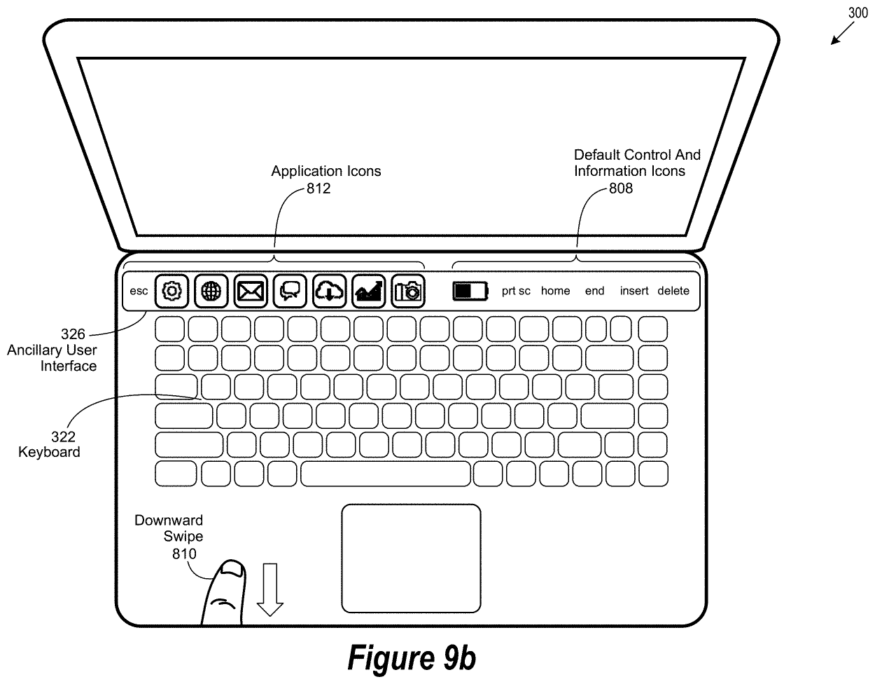

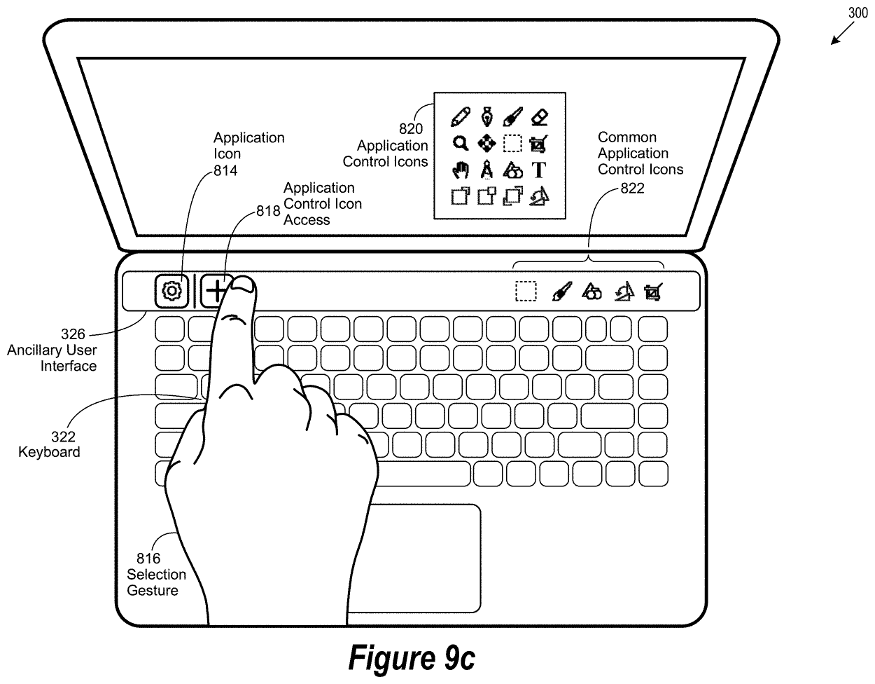

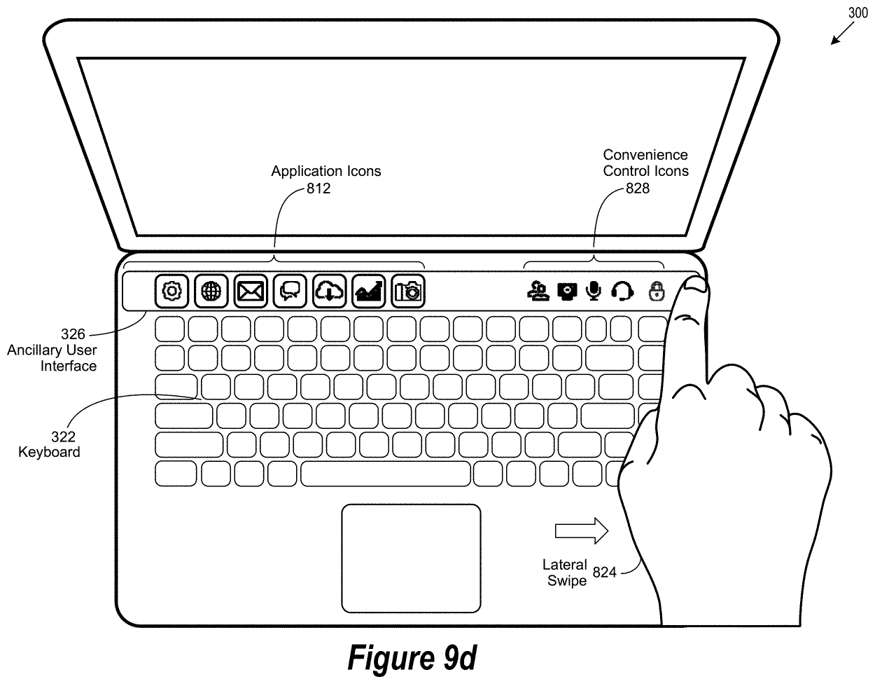

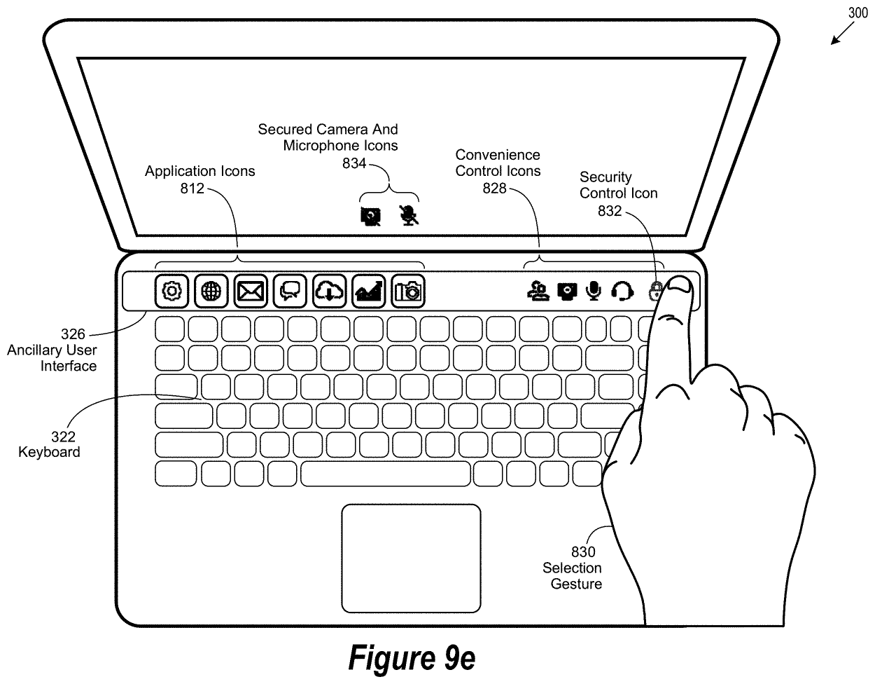

FIGS. 9a through 9e show the performance of certain user interactions with an ancillary user interface (UI) implemented in accordance with an embodiment of the invention. In this embodiment, an ancillary user interface (UI) 326 may be implemented as an adaptive row display (ARD), described in greater detail herein. As shown in FIG. 7a, the ancillary UI 326 may be implemented to display default control and information icons 708, as well as detect the proximity 906 of a human extremity, such as a finger.

As shown in FIG. 9b, the ancillary UI 326 may likewise be implemented to detect certain user gestures, such as a downward swipe 910 of a user's finger. In this embodiment, such a user gesture may result in the display of certain application icons 912, as well as retaining the display of certain default control and information icons 708. Referring now to FIG. 9c, the ancillary UI 326 may be implemented to recognize a selection gesture 916 to select an application selection icon 914, an application control icon access icon 918, or one or more common application control icons 922. For example, using a selection gesture 916 to select the application control icon access icon 918 results in the display of one or more application control icons 920.

As shown in FIG. 9d, the ancillary UI 326 may be implemented recognize a particular user gesture, such as a lateral swipe 924, which may result in the display of one or more application icons 912, one or more convenience control icons 928, or a combination thereof. Referring to FIG. 9e, the ancillary UI 326 may be implemented to recognize a selection gesture 930, which can be used to select a particular convenience control icon 928, such a security control icon 932, which may be implemented to control the operational status of an associated camera and microphone. As an example, the user device 300 shown in FIG. 9e may currently be in a privacy optimized system configuration mode. Accordingly, as indicated by the secured camera and microphone icons 934, the user device 300 has completed its boot sequence with its camera shuttered and its microphone muted, as described in greater detail herein. Skilled practitioners of the art will recognize that many such embodiments and examples are possible. Accordingly, the foregoing is not intended to limit the spirit, scope, or intent of the invention.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as JAVA, SMALLTALK, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

What is claimed is:

1. A computer-implementable method for performing a system event classification operation, comprising:
providing an information handling system with a primary integrated processor system and an ancillary integrated processor system, the primary integrated processor system executing a primary control point service, the ancillary integrated processor system executing an ancillary control point service;
classifying a system event by a particular control point action mode; and,
configuring the information handling system to automatically operate in a particular control point action mode based upon the classification of the particular control point action mode.

2. The method of claim 1, wherein:
the configuring configures a mode of system operation, the mode of system operation defining which control point actions associated with a particular system event are respectively performed by one or both the primary control point service and the ancillary control point service.

3. The method of claim 1, wherein:
the particular control point action mode includes configuration of an ancillary user interface (UI).

4. The method of claim 3, wherein:
the ancillary UI is implemented as an adaptive row display.

5. The method of claim 1, wherein:
the system event comprises at least one of a battery information display system event and a privacy mode mute system event.

6. The method of claim 1, wherein:
the particular control point action mode includes at least one of a primary control point action mode, an ancillary control point action mode and an augmented control point action mode, the primary control point action mode being a system mode of operation where the control point of a control point action is shared between the primary control point service and the ancillary control point service, the ancillary control point action mode being a system mode of operation where the control point for a control point action is performed solely by the ancillary control point service, the augmented control point action mode being a system mode of operation where the control point of the control point action is performed b y a system that is not part of the information handling system.

7. A system comprising:
a primary integrated processor system;
an ancillary integrated processor system;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
executing a primary control point service via the primary integrated processor system;
executing an ancillary control point service via the ancillary integrated processing system;
classifying a system event by a particular control point action mode; and,
configuring the information handling system to automatically operate in a particular control point action mode based upon the classification of the particular control point action mode.

8. The system of claim 7, wherein:
the configuring configures a mode of system operation, the mode of system operation defining which control point actions associated with a particular system event are respectively performed by one or both the primary control point service and the ancillary control point service.

9. The system of claim 7, wherein:
the particular control point action mode includes configuration of an ancillary user interface (UI).

10. The system of claim 9, wherein:
the ancillary UI is implemented as an adaptive row display.

11. The system of claim 7, wherein:
the system event comprises at least one of a battery information display system event and a privacy mode mute system event.

12. The system of claim 7, wherein:
the particular control point action mode includes at least one of a primary control point action mode, an ancillary control point action mode and an augmented control point action mode, the primary control point action mode being a system mode of operation where the control point of a control point action is shared between the primary control point service and the ancillary control point service, the ancillary control point action mode being a system mode of operation where the control point for a control point action is performed solely by the ancillary control point service, the augmented control point action mode being a system mode of operation where the control point of the control point action is performed b y a system that is not part of the information handling system.

13. A non-transitory, computer-readable storage medium embodying computer program code, the computer program code comprising computer executable instructions configured for:
executing a primary control point service via a primary integrated processor system;
executing an ancillary control point service via an ancillary integrated processing system;
classifying a system event by a particular control point action mode; and,
configuring the information handling system to automatically operate in a particular control point action mode based upon the classification of the particular control point action mode.

14. The non-transitory, computer-readable storage medium of claim 13, wherein:
the configuring configures a mode of system operation, the mode of system operation defining which control point actions associated with a particular system event are respectively performed by one or both the primary control point service and the ancillary control point service.

15. The non-transitory, computer-readable storage medium of claim 13, wherein:
the particular system configuration mode includes configuration of an ancillary user interface (UI).

16. The non-transitory, computer-readable storage medium of claim 15, wherein:
the ancillary UI is implemented as an adaptive row display.

17. The non-transitory, computer-readable storage medium of claim 13, wherein:
the system event comprises at least one of a battery information display system event and a privacy mode mute system event.

18. The non-transitory, computer-readable storage medium of claim 13, wherein:
the particular control point action mode includes at least one of a primary control point action mode, an ancillary control point action mode and an augmented control point action mode, the primary control point action mode being a system mode of operation where the control point of a control point action is shared between the primary control point service and the ancillary control point service, the ancillary control point action mode being a system mode of operation where the control point for a control point action is performed solely by the ancillary control point service, the augmented control point action mode being a system mode of operation where the control point of the control point action is performed b y a system that is not part of the information handling system.

19. The non-transitory, computer-readable storage medium of claim 13, wherein:
the computer executable instructions are deployable to a client system from a server system at a remote location.

20. The non-transitory, computer-readable storage medium of claim 13, wherein:
the computer executable instructions are provided by a service provider to a user on an on-demand basis.
